(19) United States
(12) Patent Application Publication
(10) Pub. No.: US 2008/0155161 A1
(43) Pub. Date: Jun. 26, 2008

(54) SMART CABLE OPTION

(76) Inventors: Clifton Broumand, Hyattsville, MD (US); Tsehay Samuel Robi, Rockville, MD (US)

Correspondence Address: CLIFTON BROUMAND, 3706 WEST STREET, LANDOVER, MD, 20785, US

(21) Appl. No.: 11/615,531

(22) Filed: Dec. 22, 2006

(51) Int. Cl. G06F 13/20

(52) U.S. Cl. 710/313

(57) ABSTRACT

This invention is about a short cable option. When PC accessories need to be repaired, replaced, cleaned or modified, a great deal of technical time is needed to remove, replace or clean the cables and accessories. This problem can be simplified by using short cables for PC accessories and connect these short cables to a powered or non-powered USB hub. The hub can then be connected to the PC USB port with one extension USB cable, one extension USB cable and USB hub power cable or with two extension cables, USB cable and USB hub power cable.

### FIELD OF THE INVENTION

The present invention relates to a cable management system for PC accessories.

### BACKGROUND OF THE INVENTION

This invention relates to a cable management system called smart cable option for PC accessories. The quantity of PC accessories connected to computers through arms. (mobile and wall mounted) has caused problems with reliability, repairs, replacement and cleaning.

The standard USB cables are six feet and 10 feet long. These long cables for PC accessories have to be routed through the arms of workstations, to be tied down and connected to the arms and extensions to minimize hazards. When the PC accessories need to be repaired, replaced, cleaned or modified, a great deal of technical time is needed to detach, clean or remove the cables and the accessories.

This problem can be simplified by using short cables for PC accessories and connect these short cables to a powered or non-powered USB hub. One cable with or without power or two, data and power, cables can be used to connect the hub to the PC USB port.

It is therefore the objective of this invention to make removing, replacing or cleaning USB accessories easier by using custom length cables that are six or 12 inches long to connect PC accessories to a hub, and a one or two cables solution that connects a hub to a PC USB port.

### SUMMARY OF THE INVENTION

Smart cable option for PC accessories makes removing, replacing or cleaning USB accessories much easier without running wires to the back of the PC. Short custom cables will be used instead of the standard long USB cables for PC accessories to connect them to a USB hub. The hub can be a powered or a non-powered hub. The USB hub will then be connected to the PC USB port. The USB extension cable can be short or long depending on how far the PC USB port is from the PC accessories. The extension cable can be a USB cable, a one-cable solution with USB cable and power cable for the hub or two cables, one USB cable and one hub power cable.

The one cable solution for data and power will have a Y-cable at both ends. At the PC end, the cable splits in to two cables; one with a regular USB A connecter and another one with a power cable connector. The USB A plugs in to a PC USB port and the power cable connects to a power adaptor. At the other end, the Y-cable will have one USB B connector, USB mini B connector or a cable that can connect to a USB hub and a hub power connector. The power connector on the USB hub end will be used as a power source for the USB hub. The length of the cable from one Y end to the other Y end can be interchangeable depending on how far the USB port on the PC is from the table, desk or cart top.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of a smart cable option for a PC accessories constructed in accordance with the invention, showing the two power end cables, the two USB ends, the two y-cable splitters and the one cable solution.

For purposes of clarity and brevity, like elements and components will bear the same designations and numbering throughout the Figures.

### DESCRIPTION OF THE PREFERRED EMBODIMENT

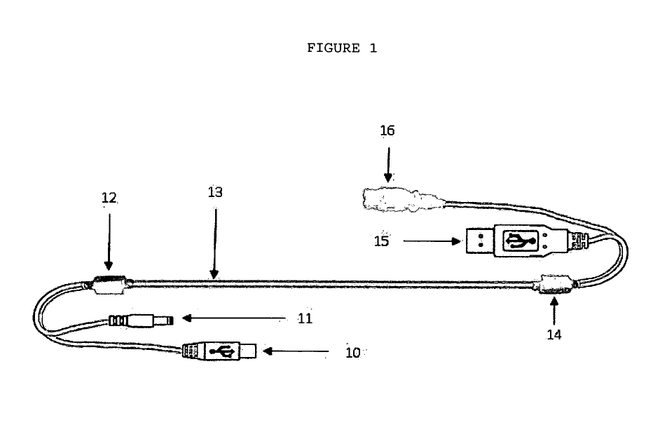

FIG. 1 is a top view of a smart cable option for PC accessories constructed in accordance with the invention. It shows both the PC and hub ends of the Y-cables. The hub end Y-cable 13 has a USB connector 10 and a USB power connector 11 that connects to the hub. The USB connector 10 can be a USB B, USB mini B or any USB connector 10 that can be used to connect to a USB hub. The one cable solution 13 connects the two ends. The PC end Y-cable has a USB A connector 15 and a USB power adaptor connector. The USB power adaptor connector is used to connect to a USB power adaptor.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A smart cable option for PC accessories, comprising: a short cable solution for PC accessories. A short custom length cables can be used to connect PC accessories to a powered or non-powered USB hub instead of the standard six feet and 12 feet length cable. The hub can then be connected to the PC USB port with one extension data cable, one extension data and power cable or with two extension cables for data and power.

2. A smart cable option for PC accessories, comprising: a one extension cable for both USB cable and USB hub power cable as shown in FIG. 1.
